(19) United States
(12) Patent Application Publication
(10) Pub. No.: US 2024/0290032 A1
(43) Pub. Date: Aug. 29, 2024

(54) SYSTEMS AND METHODS FOR PROVIDING STEREOSCOPIC VOLUMETRIC VIDEO

(71) Applicant: Tribe of Pan Inc., Toronto (CA)

(72) Inventors: Thomas Charles Mark Hall, Toronto (CA); Joanna Agnieszka Popinska, Toronto (CA)

(21) Appl. No.: 18/588,943

(22) Filed: Feb. 27, 2024

Related U.S. Application Data
(60) Provisional application No. 63/448,384, filed on Feb. 27, 2023.

(51) Int. Cl. G06T 15/20; G06T 3/40; G06T 7/593; G06T 15/04; G06T 15/08; G06T 17/20; H04N 13/00; H04N 13/243; H04N 13/296

(52) U.S. Cl. CPC G06T 15/205; G06T 3/40; G06T 7/593; G06T 15/04; G06T 15/08; G06T 17/205; H04N 13/243; H04N 13/296; G06T 2207/10028; G06T 2207/10048; H04N 2013/0081

(57) ABSTRACT

Stereoscopic volumetric video is provided using a processor-implemented method comprising: receiving captured video data of a scene from a first imaging device and a second imaging device; receiving captured depth data of the scene from a third imaging device and a fourth imaging device; combining the captured video data and the captured depth data to generate a first atlas frame sequence comprising multiple atlas frames; processing each atlas frame of the first atlas frame sequence to generate a reconstructed scene in a virtual environment; capturing each frame of the reconstructed scene using a virtual imaging device to generate a second atlas frame sequence comprising multiple atlas frames, wherein each atlas frame of the second atlas frame sequence includes virtual video data and virtual depth data of the reconstructed scene; and providing the stereoscopic volumetric video of the scene based on the virtual video data and the virtual depth data.

### CROSS-REFERENCE TO RELATED APPLICATION

This application claims the benefit of U.S. Provisional Patent Application No. 63/448,384 filed Feb. 27, 2023, and the entire contents of U.S. Provisional Patent Application No. 63/448,384 are hereby incorporated herein in its entirety.

### FIELD

The described embodiments relate to providing a video of a scene, and specifically to providing a stereoscopic volumetric video of the scene.

### BACKGROUND

Video content of a scene is typically constructed from a sequence of images that may be presented to a viewer in rapid succession. Video content may be generated by capturing multiple images of the scene using different capture technologies. The video content may be generated in different formats and can be viewed by viewers using different viewing devices.

Three-dimensional (3D) video content may provide viewers with an enhanced viewing experience compared with two-dimensional (2D) video content. However, 3D video content may require higher processing resources for capturing and rendering of the video content compared with 2D video content. The 3D content may also require higher bandwidth requirements for transmission of the captured video content to a viewer's viewing device compared with 2D video content.

### SUMMARY

In a first aspect, there is provided a computer-implemented method for providing stereoscopic volumetric video of a scene, the method comprising: receiving, by a processor, captured video data of the scene from a first imaging device and a second imaging device, the first imaging device and the second imaging device being synchronized to capture data at the same time and being positioned to provide a first overlapping field of view that includes the scene; receiving, by the processor, captured depth data of the scene from a third imaging device and a fourth imaging device, the third imaging device and the fourth imaging device being synchronized to capture data at the same time and being positioned to provide a second overlapping field of view that includes the scene; combining, by the processor, the captured video data and the captured depth data to generate a first atlas frame sequence comprising multiple atlas frames, wherein each atlas frame of the first atlas frame sequence includes the captured video data and the captured depth data for a given synchronized capture time; processing, by the processor, each atlas frame of the first atlas frame sequence to generate a reconstructed scene in a virtual environment; capturing, by the processor, each frame of the reconstructed scene using a virtual imaging device to generate a second atlas frame sequence comprising multiple atlas frames, wherein each atlas frame of the second atlas frame sequence includes virtual video data and virtual depth data of the reconstructed scene; and providing, by the processor, the stereoscopic volumetric video of the scene based on the virtual video data and the virtual depth data.

In one or more embodiments, an imaging plane of the virtual imaging device is shifted with respect to the reconstructed scene to capture a portion of the reconstructed scene at a higher image resolution compared with the other portions of the reconstructed scene.

In one or more embodiments, the method is performed to provide the stereoscopic volumetric video of the scene to a user device in real-time.

In one or more embodiments, the first imaging device and the second imaging device are high-resolution color video cameras.

In one or more embodiments, the third imaging device and the fourth imaging device are infrared depth-sensing cameras.

In one or more embodiments, the second overlapping field of view is smaller than the first overlapping field of view.

In one or more embodiments, the captured depth data is encoded using a hue saturation luminance (HSL) scale, wherein a hue value of the HSL scale includes depth information of the scene and a luminance value of the HSL scale includes mask information of the scene.

In one or more embodiments, before processing each atlas frame of the first atlas frame sequence to generate the reconstructed scene, the method further comprises editing the first atlas frame sequence to select only a portion of the first atlas frame sequence for processing.

In one or more embodiments, editing the first atlas frame sequence to select only a portion of the first atlas frame sequence for processing comprises: transcoding the first atlas frame sequence into a proxy sequence, wherein the proxy sequence corresponds to a smaller file size compared with the first atlas frame sequence; using the proxy sequence to make one or more selections; and editing the first atlas frame sequence to correspond to the one or more selections.

In one or more embodiments, the method further comprises: receiving, by the processor, intrinsics data and extrinsics data of each imaging device; and wherein processing each atlas frame of the first atlas frame sequence to generate the reconstructed scene comprises: reconstructing a frame geometry based on the captured depth data, the intrinsics data of the third imaging device and the fourth imaging device, and the extrinsics data of the third imaging device and the fourth imaging device; and projecting the captured video data onto the frame geometry using a first pass corresponding to video data captured by the first imaging device and based on the intrinsics data and the extrinsics data of the first imaging device, and a second pass corresponding to video data captured by the second imaging device and based on the intrinsics data and the extrinsics data of the second imaging device.

In one or more embodiments, the portion of the reconstructed scene captured at the higher image resolution includes a face portion of a subject.

In one or more embodiments, capturing each frame of the reconstructed scene using a virtual imaging device to generate a second atlas frame sequence comprises: capturing first virtual video data in a first capture pass corresponding to a left eye perspective of a viewer of the stereoscopic volumetric video; capturing second virtual video data in a second capture pass corresponding to a right eye perspective of a viewer of the stereoscopic volumetric video; and capturing the virtual depth data of the reconstructed scene in relation to a virtual location of the virtual imaging device in the virtual environment.

In one or more embodiments, the virtual depth data is encoded using a hue saturation luminance (HSL) scale, wherein a hue value of the HSL scale includes virtual depth information of the reconstructed scene in relation to the virtual location and a luminance value of the HSL scale includes mask information of the reconstructed scene.

In one or more embodiments, providing the stereoscopic volumetric video of the scene based on the virtual video data and the virtual depth data comprises: generating a first UV map corresponding to the first virtual video data, the first UV map usable to apply material to an output mesh to generate rendering corresponding to the left eye perspective of the viewer of the stereoscopic volumetric video; generating a second UV map corresponding to the second virtual video data, the second UV map usable to apply material to the output mesh to generate rendering corresponding to the right eye perspective of the viewer of the stereoscopic volumetric video; and generating a third UV map corresponding to the virtual depth data, the third UV map usable to displace vertices of the output mesh to recreate geometry of the scene.

In a second aspect, there is provided a system for providing stereoscopic volumetric video of a scene, the system comprising a processor and a memory storing instructions executable by the processor. The processor is in communication with a first imaging device, a second imaging device, a third imaging device and a fourth imaging device, wherein: the first imaging device and the second imaging device are positioned to provide a first overlapping field of view that includes the scene and are synchronized to capture video data of the scene at the same time; and the third imaging device and the fourth imaging device are positioned to provide a second overlapping field of view that includes the scene and are synchronized to capture depth data at the same time. The processor is configured to: receive the captured video data of the scene from the first imaging device and the second imaging device; receive the captured depth data of the scene from the third imaging device and the fourth imaging device; combine the captured video data and the captured depth data to generate a first atlas frame sequence comprising multiple atlas frames, wherein each atlas frame of the first atlas frame sequence includes the captured video data and the captured depth data for a given synchronized capture time; process each atlas frame of the first atlas frame sequence to generate a reconstructed scene in a virtual environment; capture each frame of the reconstructed scene using a virtual imaging device to generate a second atlas frame sequence comprising multiple atlas frames, wherein each atlas frame of the second atlas frame sequence includes virtual video data and virtual depth data of the reconstructed scene; and provide the stereoscopic volumetric video of the scene based on the virtual video data and the virtual depth data.

In one or more embodiments, an imaging plane of the virtual imaging device is shifted with respect to the reconstructed scene to capture a portion of the reconstructed scene at a higher image resolution compared with the other portions of the reconstructed scene.

In one or more embodiments, the processor is configured to provide the stereoscopic volumetric video of the scene to a user device in real-time.

In one or more embodiments, the first imaging device and the second imaging device are high-resolution color video cameras.

In one or more embodiments, the third imaging device and the fourth imaging device are infrared depth-sensing cameras.

In one or more embodiments, the second overlapping field of view is smaller than the first overlapping field of view.

In one or more embodiments, the captured depth data is encoded using a hue saturation luminance (HSL) scale, wherein a hue value of the HSL scale includes depth information of the scene and a luminance value of the HSL scale includes mask information of the scene.

In one or more embodiments, the processor is further configured to edit the first atlas frame sequence to select only a portion of the first atlas frame sequence for processing to generate the reconstructed scene.

In one or more embodiments, the processor being configured to edit the first atlas frame sequence to select only a portion of the first atlas frame sequence for processing comprises the processor being configured to: transcode the first atlas frame sequence into a proxy sequence, wherein the proxy sequence corresponds to a smaller file size compared with the first atlas frame sequence; use the proxy sequence to make one or more selections; and edit the first atlas frame sequence to correspond to the one or more selections.

In one or more embodiments, the processor is further configured to receive intrinsics data and extrinsics data of each imaging device; and wherein the processor being configured to process each atlas frame of the first atlas frame sequence to generate the reconstructed scene comprises the processor being configured to: reconstruct a frame geometry based on the captured depth data, the intrinsics data of the third imaging device and the fourth imaging device, and the extrinsics data of the third imaging device and the fourth imaging device; and project the captured video data onto the frame geometry using a first pass corresponding to video data captured by the first imaging device and based on the intrinsics data and the extrinsics data of the first imaging device, and a second pass corresponding to video data captured by the second imaging device and based on the intrinsics data and the extrinsics data of the second imaging device.

In one or more embodiments, the portion of the reconstructed scene captured at the higher image resolution includes a face portion of a subject.

In one or more embodiments, the processor being configured to capture each frame of the reconstructed scene using a virtual imaging device to generate a second atlas frame sequence comprises the processor being configured to: capture first virtual video data in a first capture pass corresponding to a left eye perspective of a viewer of the stereoscopic volumetric video; capture second virtual video data in a second capture pass corresponding to a right eye perspective of a viewer of the stereoscopic volumetric video; and capture the virtual depth data of the reconstructed scene in relation to a virtual location of the virtual imaging device in the virtual environment.

In one or more embodiments, the virtual depth data is encoded using a hue saturation luminance (HSL) scale, wherein a hue value of the HSL scale includes virtual depth information of the reconstructed scene in relation to the virtual location and a luminance value of the HSL scale includes mask information of the reconstructed scene.

In one or more embodiments, the processor being configured to provide the stereoscopic volumetric video of the scene based on the virtual video data and the virtual depth data comprises the processor being configured to: generate a first UV map corresponding to the first virtual video data, the first UV map usable to apply material to an output mesh to generate rendering corresponding to the left eye perspective of the viewer of the stereoscopic volumetric video; generate a second UV map corresponding to the second virtual video data, the second UV map usable to apply material to the output mesh to generate rendering corresponding to the right eye perspective of the viewer of the stereoscopic volumetric video; and generate a third UV map corresponding to the virtual depth data, the third UV map usable to displace vertices of the output mesh to recreate geometry of the scene.

### BRIEF DESCRIPTION OF THE DRAWINGS

The drawings included herewith are for illustrating various examples of systems, methods, and devices of the teaching of the present specification and are not intended to limit the scope of what is taught in any way.

FIG. 1 shows a block diagram of an example system for providing stereoscopic volumetric video of a scene, in accordance with one or more embodiments.

FIGS. 2A and 2B show field of view of imaging devices of the example system of FIG. 1.

FIG. 3 shows a block diagram of a processing system of the example system of FIG. 1.

FIG. 4 shows a flowchart of an example method for providing a stereoscopic volumetric video, in accordance with one or more embodiments.

FIG. 5 shows a visual representation of an example atlas frame generated using the method of FIG. 4.

FIG. 6 shows a visual representation of an example partially reconstructed scene in a virtual environment using the method of FIG. 4.

FIG. 7 shows a visual representation of an example reconstructed scene in a virtual environment using the method of FIG. 4.

FIG. 8A shows visual representations of the reconstructed scene of FIG. 7 and example virtual video data and virtual depth data captured from the reconstructed scene.

FIG. 8B shows a visual representation of an example atlas frame generated for the reconstructed scene of FIG. 7.

FIG. 9A shows an example vertex mesh, in accordance with one or more embodiments.

FIG. 9B shows a visual representation of an example greyscale depth map and an example mask based on the virtual depth data of FIG. 8B.

FIG. 9C shows a visual representation of the vertex mesh of FIG. 9A that is partially modified based on the virtual video data and virtual depth data of FIG. 8B.

FIG. 9D shows a visual representation of a rendering generated after modifying the vertex mesh of FIG. 9A based on the virtual video data and virtual depth data of FIG. 8B.

### DESCRIPTION OF EXEMPLARY EMBODIMENTS

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

It should be noted that terms of degree such as “substantially”, “about” and “approximately” when used herein mean a reasonable amount of deviation of the modified term such that the end result is not significantly changed. These terms of degree should be construed as including a deviation of the modified term if this deviation would not negate the meaning of the term it modifies.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, personal computer, laptop, personal data assistant, cellular telephone, smart-phone device, tablet computer, wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and a combination thereof.

Program code may be applied to input data to perform the functions described herein and to generate output information. The output information is applied to one or more output devices, in known fashion.

Each program may be implemented in a high-level procedural or object-oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the systems, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloads, magnetic and electronic storage media, digital and analog signals, and the like. The computer useable instructions may also be in various forms, including compiled and non-compiled code.

Various embodiments have been described herein by way of example only. Various modifications and variations may be made to these example embodiments without departing from the spirit and scope of the invention, which is limited only by the appended claims. Also, in the various user interfaces illustrated in the figures, it will be understood that the illustrated user interface text and controls are provided as examples only and are not meant to be limiting. Other suitable user interface elements may be possible.

The present disclosure provides systems and methods usable to provide stereoscopic volumetric video of a scene. The scene may be of any duration and include any object or environment. For example, the duration of the scene may range from a few seconds to many hours. The scene may include persons, animals or inanimate objects (e.g., cars). The environment may be an indoor environment (e.g., a studio or a living room) or an outdoor environment (e.g., a highway or a park). As one specific example, the scene may include a 20-minute interview with a person in a studio environment. As another specific example, the scene may include a 10-second sequence of a car driving along a road.

The stereoscopic volumetric video provided by the disclosed systems and methods may include video data for providing a stereoscopic viewing experience to a viewer that includes separate left-eye and right-eye image texture information (e.g., the stereoscopic volumetric video may include video data for multiple image frames and the video data for each image frame may include separate left-eye and right-eye RGB image texture information).

The stereoscopic volumetric video provided by the disclosed systems and methods may also include video data for providing a volumetric viewing experience to a viewer. The stereoscopic volumetric video may include video data for providing a viewer a better 3D viewing experience compared with a 3D video presentation that only relies on a parallax effect between the left and right eye images to produce the 3D effect. The disclosed systems and methods can provide the stereoscopic volumetric video in a volumetric space to a viewer such that the parallax is nearly zero across each image frame of the video. This may enable the viewer to move their head without experiencing the typical eye strain associated with high parallax images. Further, the stereoscopic volumetric video can include distinct left-eye and right-eye images for each image frame of the video, thus enabling a viewer to pick up retinal rivalry clues that are important for scene perception of human viewers.

The disclosed systems and methods can also provide a stereoscopic volumetric video of a scene in real-time and may be used in applications requiring a real-time rendering pipeline. For example, the disclosed systems and methods can provide stereoscopic volumetric video for telepresence and live streaming applications.

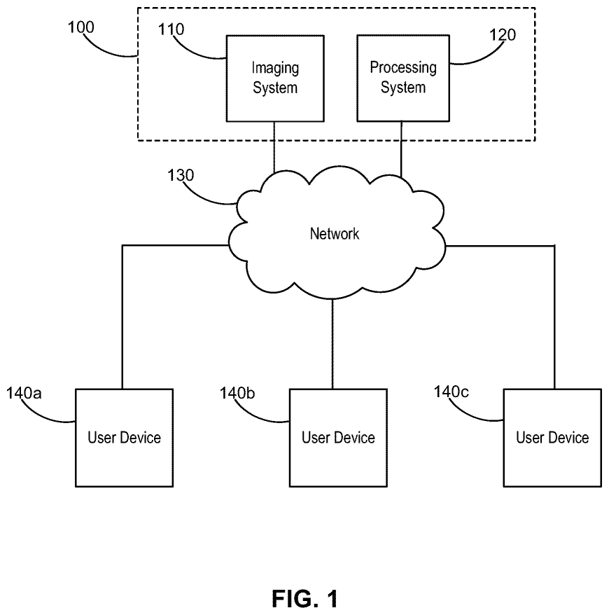

Referring first to FIG. 1, shown therein is a block diagram of an example system 100 for providing stereoscopic volumetric video of a scene to user devices 140a-140c via a network 130. The user devices 140a-140c may also be collectively referred to as user device(s) 140. System 100 may include an imaging system 110 and a processing system 120.

Imaging system 110 can have any design suitable for capturing video data and depth data of the scene. Imaging system 110 may include any number of imaging devices to capture the video data and depth data. For example, imaging system 110 may include multiple color video cameras to capture the video data. Imaging system 110 may also include multiple infrared depth-sensing cameras to capture the depth data.

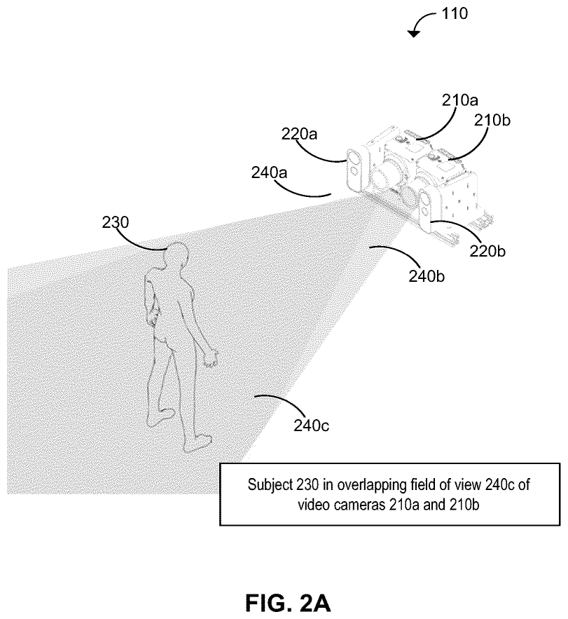

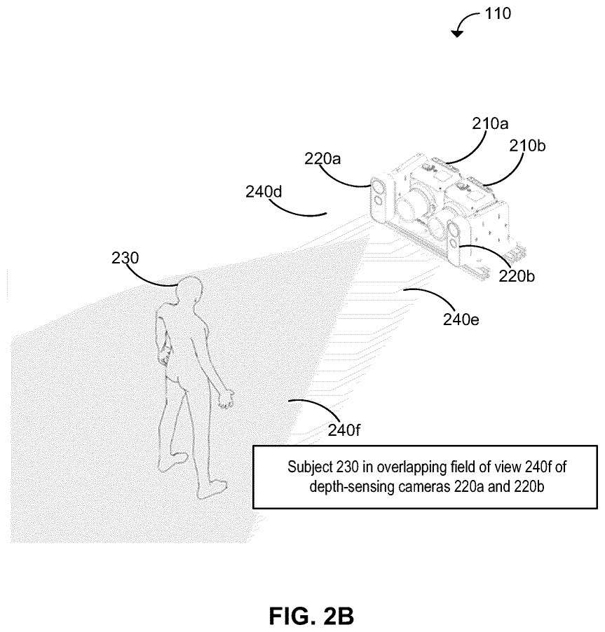

Reference is now made to FIGS. 2A and 2B showing field of view 240a-240f (also collectively referred to herein as field of view 240) of example imaging devices of imaging system 110. The imaging system 110 may be used to capture a scene including a human subject 230. In the illustrated example, imaging system 110 includes video cameras 210a and 210b (also collectively referred to herein as video camera(s) 210), and depth-sensing cameras 220a and 220b (also collectively referred to herein as depth-sensing camera(s) 220). In other examples, imaging system 110 may include additional video cameras 210 and/or additional depth-sensing cameras 220. The additional video cameras and/or depth sensing cameras may provide additional video data and/or additional depth data from different viewing positions/angles.

Video cameras 210a and 210b may be positioned adjacent to each other such that field of view 240a of video camera 210a and field of view 240b of video camera 210b are overlapping to provide an overlapping field of view 240c. The overlapping field of view 240c may include the scene to be captured (human subject 230 in the illustrated example). For example, video cameras 210a and 210b may be positioned beside each other to mimic the left-eye and right-eye perspectives of a viewer. In some embodiments, the field of view 240a and 240b (and thereby the overlapping field of view 240c) may be changed by changing the lenses of video cameras 210.

The captured video data by video cameras 210 may include a sequence of image frames of the scene. In some embodiments, video cameras 210a and 210b may be synchronized to capture stereo video data at the same time. For example, a synchronized trigger signal may be provided to video cameras 210a and 210b so that image sensors of video cameras 210a and 210b capture each image frame included in the captured video data at the same synchronized time. In some embodiments, each image frame of the captured video data may include a timestamp corresponding to the synchronized capture time.

Video cameras 210 can provide the captured synchronized stereo video data of the scene to a processing system (e.g., processing system 120 of FIG. 1). For example, video cameras 210 can transmit the captured video data to the processing system in real-time to enable real-time processing and streaming of the stereoscopic volumetric video to a viewer. In some embodiments, video cameras 210 may store the captured video data for offline processing. For example, video camera 210 may store the captured video data in an internal memory of video camera 210. In some embodiments, video camera 210 may transmit the captured video data to an external memory for storage.

In some embodiments, video cameras 210 are high-resolution color video cameras that capture high-resolution color video data of the scene. For example, video camera 210 may be a Z Cam E2® camera. In other embodiments, a video camera 210 may not be a high-resolution camera, for example, an application that uses lower processing and bandwidth resources and where a lower resolution video is acceptable.

Depth-sensing cameras 220a and 220b may be positioned such that the field of view 240d of depth-sensing camera 220a and the field of view 240e of depth-sensing camera 220b overlap with each other to provide an overlapping field of view 240f. The depth-sensing cameras 220a and 220b may be positioned in physical proximity to video cameras 240a and 240b such that the overlapping field of view 240f overlaps with the overlapping field of view 240c and includes the scene to be captured (human subject 230 in the illustrated example). For example, as shown in FIGS. 2A and 2B, depth-sensing cameras 220a and 220b may be positioned on either side of video cameras 240a and 240b. In some embodiments, the field of view 240d and 240e (and thereby the overlapping field of view 240f) may be changed by changing the lenses of depth-sensing cameras 220. Using two or more depth-sensing cameras 220 may enable filling in of occlusion, for example, where a foreground object casts a shadow on subject 230.

The captured depth data by depth-sensing cameras 220 may include a sequence of image frames with depth data of the scene. In some embodiments, the captured depth data may be encoded using greyscale values. For example, a greyscale value of 0 may be used for a maximum depth and a greyscale value of 1 may be used for a minimum depth. The captured depth data by depth-sensing cameras 220 may then include a sequence of greyscale image frames representing depth data of the scene.

In some embodiments, the captured depth data may be encoded using a hue saturation luminance (HSL) scale. For example, a hue value of the HSL scale may include depth information of the scene. A hue value of 0 may be used for a maximum depth and a hue value of 360 may be used for a minimum depth. Using the HSL scale for encoding the captured depth data may enable a higher resolution of depth values compared with using greyscale values. For example, an 8-bit greyscale image has 0-255 steps (grey) in each color channel while the hue values are shared across each of the color channels, thereby increasing the number of steps available to encode the depth data. In some embodiments, a mask information of the image may be encoded using the luminance value. For example, luminance value of white may correspond to depth data and luminance value of black may correspond to zero or no data. In some embodiments, the saturation value may also include the mask information to enable noise reduction during subsequent processing. The mask information may enable culling areas not of interest in the scene. This may improve the processing efficiency of system 100 by reducing the amount of data processed during subsequent processing steps.

In some embodiments, depth-sensing cameras 220a and 220b may be synchronized to capture depth data at the same time. For example, a synchronized trigger signal may be provided to depth-sensing cameras 220a and 220b so that image sensors of depth-sensing cameras 220a and 220b capture each image frame included in the captured depth data at the same synchronized time. In some embodiments, each image frame of the captured depth data may include a timestamp corresponding to the synchronized capture time.

Depth-sensing cameras 220 can provide the captured synchronized depth data of the scene to a processing system (e.g., processing system 120 of FIG. 1). For example, depth-sensing cameras 220 can transmit the captured depth data to the processing system in real-time to enable real-time processing and streaming of the stereoscopic volumetric video to a viewer. In some embodiments, depth-sensing cameras 220 may store the captured depth data for offline processing. For example, depth-sensing cameras 220 may store the captured depth data in an internal memory of depth-sensing cameras 220 or transmit the captured depth data to an external memory for storage.

In some embodiments, depth-sensing cameras 220 are infrared depth-sensing cameras that capture depth data of the scene. For example, depth-sensing cameras 220 may be Microsoft Azure Kinect® modules.

In some embodiments, the overlapping field of view 240f of depth-sensing cameras 220 may be smaller than the overlapping field of view 240c of video cameras 210. This may enable the captured depth image data from depth-sensing cameras 220 to be used as an anchor image (for each captured image frame) to which the captured image frames from video cameras 210 can be aligned.

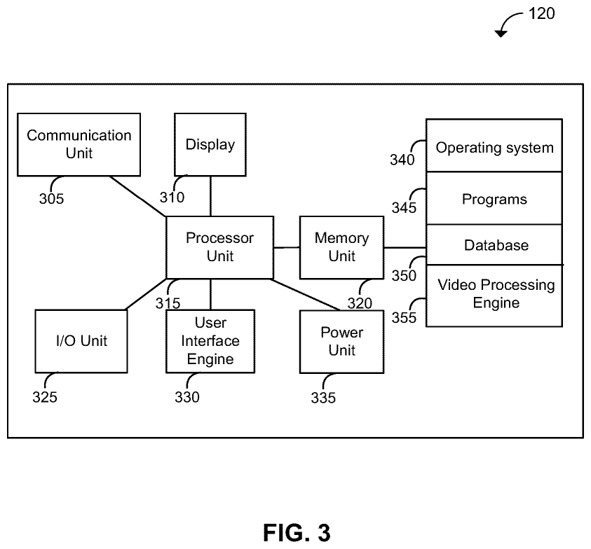

Reference is now made to FIG. 1 and FIG. 3. FIG. 3 shows a block diagram of processing system 120. The processing system 120 can have any design suitable for processing the video data and depth data captured by imaging system 110. In the illustrated example, processing system 120 includes a communication unit 305, a display 310, a processor unit 315, a memory unit 320, an I/O unit 325, a user interface engine 330 and a power unit 335.

In some embodiments, processing system 120 and imaging system 110 may be in close physical proximity. For example, processing system 120 and imaging system 110 may be integrated into a common housing or enclosure. The processing system 120 and imaging system 110 may be in direct communication with each other, for example, using wired or wireless communication technologies. In some embodiments, processing system 120 may be located physically remote from imaging system 110. The processing system 120 and the imaging system 110 may communicate with each other using one or more communication networks (e.g., network 130).

Communication unit 305 can include wired or wireless connection capabilities. Communication unit 305 can be used by processing system 120 to communicate with other devices or computers. For example, processing system 120 may use communication unit 305 to receive, via network 130, at least some of the captured video data and/or the captured depth data from imaging system 110. As another example, processing system 120 may provide, via network 130, stereoscopic volumetric video of a scene to user devices 140.

Processor unit 315 can control the operation of processing system 120. Processor unit 315 can be any suitable processor, controller or digital signal processor that can provide sufficient processing power depending on the configuration, purposes and requirements of processing system 120 as is known by those skilled in the art. For example, processor unit 315 may be a high-performance general processor. For example, processor unit 315 may include a standard processor, such as an Intel® processor, or an AMD® processor. Alternatively, processor unit 315 can include more than one processor with each processor being configured to perform different dedicated tasks. Alternatively, specialized hardware (e.g., graphical processing units (GPUs)) can be used provide some of the functions provided by processor unit 315.

In some embodiments, processor unit 315 may also provide control signals to control the operation of imaging system 110. For example, processor unit 315 may provide control signals to imaging system 110 specifying start and stop times for capturing video data and depth data.

Processor unit 315 can execute a user interface engine 330 that may be used to generate various user interfaces. User interface engine 330 may be configured to provide a user interface on display 310. Optionally, processing system 120 may be in communication with external displays via network 130. User interface engine 330 may also generate user interface data for the external displays that are in communication with processing system 120.

User interface engine 330 can be configured to provide a user interface to enable set-up and initialization of the processing system 120 and/or the imaging system 110. User interface engine 330 can also be configured to provide a user interface to receive inputs specifying capture parameters of imaging system 110 and/or video processing parameters of processing system 120. In some embodiments, user interface engine 330 can be configured to provide a user interface to receive inputs controlling output parameters for a stereoscopic volumetric video provided to user device 140.

Display 310 may be a LED or LCD based display and may be a touch sensitive user input device that supports gestures. Display 310 may be integrated into processing system 120. Alternatively, display 310 may be located physically remote from processing system 120 and communicate with processing system 120 using a communication network, for example, network 130.

I/O unit 325 can include at least one of a mouse, a keyboard, a touch screen, a thumbwheel, a trackpad, a trackball, a card-reader, voice recognition software and the like, depending on the particular implementation of processing system 120. In some cases, some of these components can be integrated with one another. I/O unit 325 may enable an operator or an administrator of processing system 120 to interact with the user interfaces provided by user interface engine 330.

Power unit 335 can be any suitable power source that provides power to processing system 120 such as a power adaptor or a rechargeable battery pack depending on the implementation of processing system 120 as is known by those skilled in the art.

Memory unit 320 includes software code for implementing an operating system 340, programs 345, database 350 and video processing engine 355.

Memory unit 320 can include RAM, ROM, one or more hard drives, one or more flash drives or some other suitable data storage elements such as disk drives, etc. Memory unit 320 can be used to store an operating system 340 and programs 345 as is commonly known by those skilled in the art. For instance, operating system 340 provides various basic operational processes for processing system 120. For example, the operating system 340 may be an operating system such as Windows® Server operating system, or Red Hat® Enterprise Linux (RHEL) operating system, or another operating system.

Database 350 may include a Structured Query Language (SQL) database such as PostgreSQL or MySQL or a not only SQL (NoSQL) database such as MongoDB, or Graph Databases, etc. Database 350 may be integrated with processing system 120. Alternatively, database 350 may run independently on a database server in network communication (e.g., via network 130) with processing system 120.

Database 350 may store the captured video data and/or the captured depth data received from imaging system 110. Database 350 may also store control parameters like video capture parameters for imaging system 110, video processing parameters for processing system 120, and/or video output parameters for providing a stereoscopic volumetric video to user devices 140. In some embodiments, database 350 may also store the stereoscopic volumetric video of a scene for future retrieval.

Programs 345 can include various programs so that processing system 120 can perform various functions such as, but not limited to, receiving captured video data, receiving captured depth data, processing received data, and providing a stereoscopic volumetric video of a scene to user devices 140.

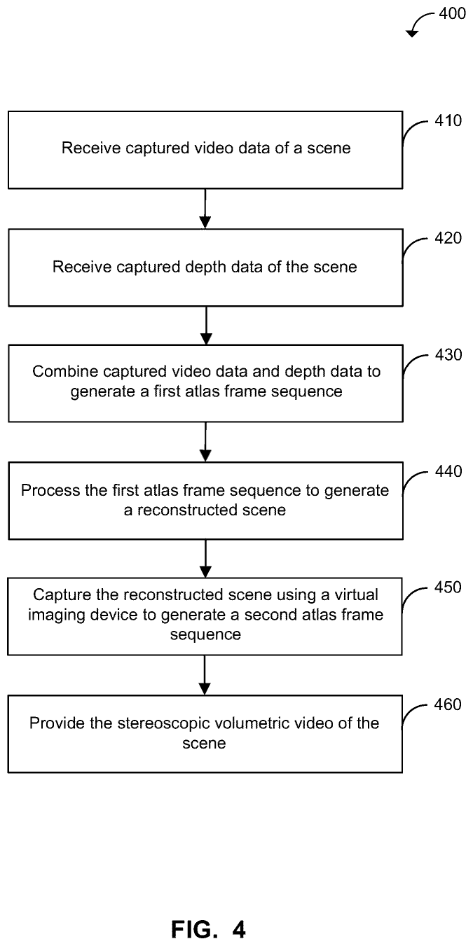

Video processing engine 355 can process captured video data and depth data of a scene to provide a stereoscopic volumetric video of the scene, for example, as described in further detail herein below with reference to FIG. 4.

In some embodiments, video processing engine 355 may receive the captured video data and depth data of a scene in real-time from imaging system 110. Video processing engine 355 may process the captured video data and depth data in real-time to provide a real-time stereoscopic volumetric video of the scene (e.g., for telepresence or live streaming applications).

In some embodiments, video processing engine 355 may receive the captured video data and depth data that was previously stored in database 350 or an external storage device. Video processing engine 355 may process the captured video data and depth data to generate a stereoscopic volumetric video of the scene that may be provided to user devices 140 or stored (e.g., in database 350) for future viewing.

Referring now to FIG. 1, network 130 may be a communication network such as the Internet, a Wide-Area Network (WAN), a Local-Area Network (LAN), or another type of network. Network 104 may include a point-to-point connection, or another communications connection between two nodes.

User devices 140 may be any suitable devices that enables a viewer/user of user device 140 to view a stereoscopic volumetric video. The stereoscopic volumetric video may be provided to user devices 140 by, for example, processing system 120. The user devices 140 may need to be capable of delivering separate images to a viewer's left and right eyes to enable the viewer to fully experience the stereoscopic volumetric video. For example, a user device 140 may be a 6 degrees of freedom virtual reality (VR) headset that can enable a viewer to move in space to experience the spatial data provided by the stereoscopic volumetric video and enable presentation of natural retinal rivalries by feeding independent image texture information to the left and right eyes of the viewer. As another example, user device 140 may be a head-mounted display (HMD) based augmented reality (AR) device that can render distinct left and right eye images overlayed into a viewer's vision. As another example, user device 140 may include light field displays or lenticular displays (e.g., Looking Glass® device) where a wave guide can direct distinct left and right eye images to a viewer.

Referring now to FIG. 4, shown therein is a flowchart of an example method 400 for providing a stereoscopic volumetric video of a scene. Method 400 can be implemented using, for example, system 100 and reference is made concurrently to FIGS. 1-3 showing system 100 and its components.

Method 400 can be performed at various times. For example, method 400 may be performed in response to input received from an administrator or operator of system 100. Method 400 may also be performed in response to a user/viewer providing an input using a user device (e.g., user devices 140 shown in FIG. 1). Method 400 may also be performed automatically, for example, according to a stored schedule (e.g., a schedule stored in database 350 shown in FIG. 3).

At 410, method 400 may include receiving captured video data of the scene. The captured video data may be received from imaging devices of an imaging system (e.g., imaging system 110 shown in FIG. 1). In some embodiments, each image frame of the captured video data may include captured RGB image data of the scene. The captured video data may include stereoscopic video data captured by multiple synchronized video cameras (e.g., video cameras 210a and 210b shown in FIGS. 2A and 2B). For each synchronized capture time, the captured video data may include a RGB image frame captured by each of the video cameras 210a and 210b.

In some embodiments, method 400 may include receiving the captured video data in real-time (e.g., telepresence or live streaming applications). In other embodiments, method 400 may receive the captured video data from a storage device (e.g., database 350 shown in FIG. 3).

At 420, method 400 may include receiving captured depth data of the scene. The captured depth data may be received from imaging devices of an imaging system (e.g., imaging system 110). In some embodiments, each depth image frame of the captured depth data may include depth data of the scene. The depth image frame include depth information of the scene encoded, for example, in a HSL scale or a greyscale. The depth data may be captured by multiple synchronized depth-sensing cameras (e.g., depth-sensing cameras 220a and 220b shown in FIGS. 2A and 2B). For each synchronized capture time, the captured depth data may include a HSL or greyscale image frame captured by each of the depth-sensing cameras 220a and 220b.

Method 400 may include receiving the captured depth data in real-time (e.g., telepresence or live streaming applications). In some embodiments, method 400 may receive the captured depth data from a storage device (e.g., database 350).

At 430, method 400 may include combining the captured video data and the captured depth data to generate a first atlas frame sequence. The first atlas frame sequence may include multiple atlas frames. Each atlas frame may correspond to a synchronized capture time of the imaging devices.

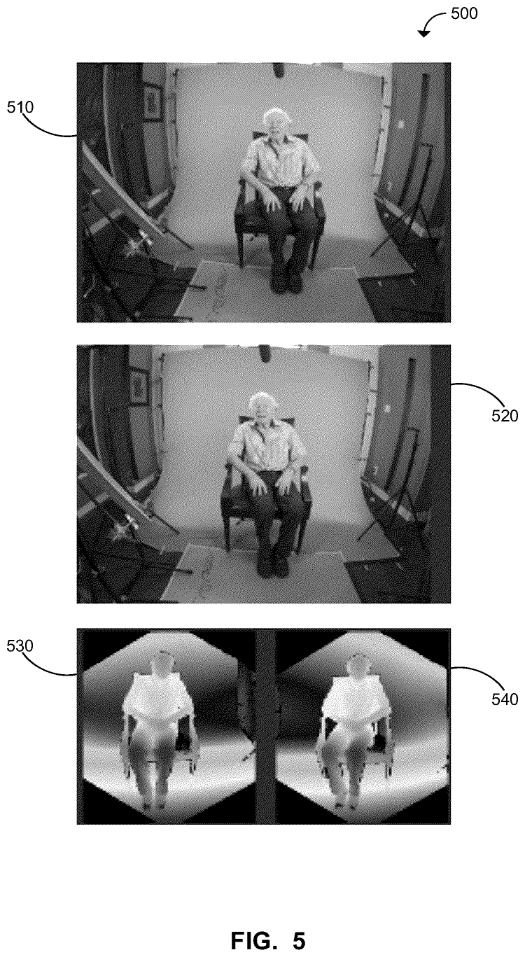

Referring now to FIG. 5, shown therein is a visual representation of an example atlas frame 500. The atlas frame 500 may include captured video data 510, 520 and captured depth data 530, 540. For example, the captured video data 510 and 520 can be captured RGB image frames of the scene for a synchronized capture time by video cameras 210a and 210b respectively. The captured depth data 530 and 540 can be HSL depth image frames including captured depth information of the scene for a corresponding synchronized capture time by depth-sensing cameras 220a and 220b respectively.

The synchronized capture time of depth-sensing cameras 220 corresponding to a synchronized capture time of video cameras 210 may be determined automatically. For example, the captured video data may include timestamp metadata associated with each captured RGB image frame and the captured depth data may include timestamp metadata associated with each HSL depth image frame. Method 400 may include automatically synchronizing (e.g., by processing system 120 shown in FIGS. 1 and 3) the captured RGB images frames and the HSL depth image frames using the timestamp metadata. In some embodiments, method 400 may include manually synchronizing the captured RGB image frames and the HSL depth image frames by lining them up using a clapper board.

The first atlas frame sequence may be generated in any suitable format. For example, the first atlas frame sequence may be generated in a high-resolution video format such as Apple® Prores4444. In some embodiments, the first atlas frame sequence may also include additional data, for example audio data and metadata such as scene and take numbers of the captured scene.

The first atlas frame sequence may be streamed to provide a real-time stereoscopic volumetric video or may be stored in a storage device. The first atlas frame sequence may include a combination of all the captured/received data. For example, the first atlas frame sequence may include the captured video data, depth data, audio data as well as associated metadata. This may provide an advantage for subsequent processing/editing compared with methods where the different data are independently streamed/stored and where specialized multiplexing software may be required to process the data.

In some embodiments, method 400 may include editing the first atlas frame sequence generated at 430 before further processing at 440. The editing can include, for example, selecting only a portion of the first atlas frame sequence for further processing at 440. This may improve the overall processing and/or bandwidth efficiency of the system because only the selected portion is further processed/transmitted.

In some embodiments, the first atlas frame sequence that includes a combination of all the captured data may be a large file and consume significant computing resources during the editing process. The first atlas frame sequence may be transcoded into a smaller proxy file to reduce the computing resources needed during the editing process. For example, transcoding tools like Adobe Media Encoder® or FFMPEG® may be used to transcode the generated atlas frame sequence into a smaller proxy file. In some embodiments, the smaller proxy file may be a lower resolution version of the atlas frame sequence.

The smaller proxy file may be used during the editing process, for example, to select portions of the first atlas frame sequence for further processing at 440. The selection may be performed using a non-linear editing (NLE) tool like Adobe Premiere®, Davinci Resolve® or Final Cut X®. The selections made in the smaller proxy file may then be transferred to the first atlas frame sequence to select the corresponding portions of the first atlas frame sequence for further processing at 440. In some embodiments (for example, live streaming applications), method 400 may not include the editing process and the entire first atlas frame sequence may be further processed at 440.

Referring back to FIG. 4, at 440, method 400 may include processing each atlas frame of a received atlas frame sequence to generate a reconstructed scene in a virtual environment. The processing may be performed, for example, by video processing engine 355 shown in FIG. 3.

The received atlas frame sequence at 440 may be the first atlas frame sequence generated at 430. In some embodiments, the received atlas frame sequence at 440 may only include the selected portion of the first atlas frame sequence.

The virtual environment at 440 may include, for example, a VFX compositing environment. In some embodiments (for example, real-time streaming applications), the VFX compositing environment can be a real-time rendering environment such as TouchDesigner®, Unity 3D®, or Unreal® engine. In some embodiments, the VFX compositing environment can be an offline rendering tool such as Nuke® or Fusion®.

At 440, each atlas frame of the received atlas frame may be cropped back into separate sections, for example, sections corresponding to the captured RGB image frames and the HSL depth image frames. The captured scene may be reconstructed, frame by frame, in the virtual environment using the separate sections for each atlas frame.

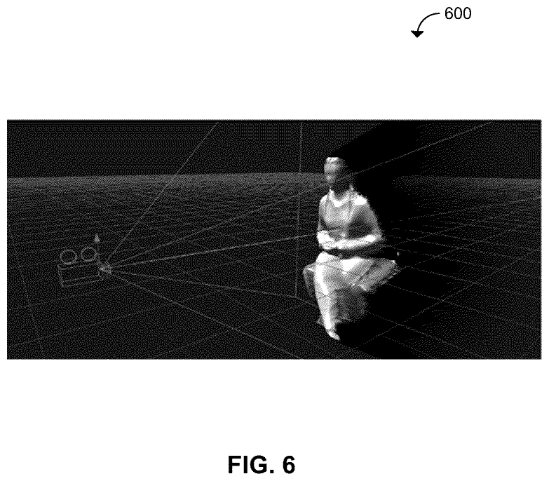

Referring now to FIG. 6, shown therein is a visual representation 600 of a partially reconstructed scene in the virtual environment for an example atlas frame. The partial reconstruction may include a reconstructed frame geometry based on the captured depth data included in the example atlas frame. For example, the captured depth data may include depth data captured by depth-sensing cameras 220a and 220b. The frame geometry may be reconstructed by mapping the depth information encoded in the captured depth data to the 3D virtual environment.

In some embodiments, the frame geometry may be reconstructed based on the depth data captured by depth-sensing cameras 220a and 220b, and the intrinsics data and extrinsics data of the depth-sensing cameras 220a and 220b. The intrinsics data and extrinsics data of the depth sensing cameras 220a and 220b may be received from imaging system 110. In some embodiments, the received intrinsics data and extrinsics data may be stored in database 350. The intrinsics data may include, for example, the focal length, aperture, field-of-view, and/or resolution of depth-sensing cameras 220a and 220b. The extrinsics data may include, for example, the position and orientation of depth-sensing cameras 220a and 220b in relation to the scene and/or video cameras 210.

During the reconstruction, any holes in the captured depth data may be filled in using filters, for example, gaussian blur or edge node. In some embodiments, unwanted data such as rigging or lights may be removed from the captured depth data. The unwanted data may be manually removed, for example, by an operator of processing system 120.

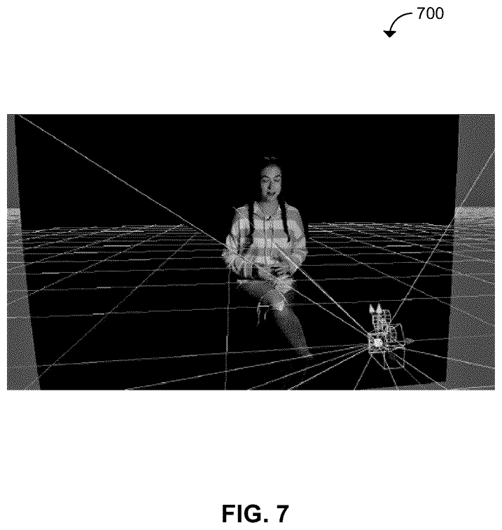

Referring now to FIG. 7, shown therein is a visual representation 700 of a reconstructed scene in the virtual environment for an example atlas frame. The reconstruction may be performed by projecting the captured video data of the example atlas frame onto the reconstructed frame geometry. The projection may be performed using multiple passes. The number of passes may correspond to the number of video cameras used to capture the video data included in the atlas frame. The projection during each pass may be based on the intrinsics and extrinsics data of the video camera used to capture the video data.

The intrinsics data and extrinsics data of the video cameras may be received from the imaging system (e.g., imaging system 110). In some embodiments, the received intrinsics data and extrinsics data may be stored in database 350. The intrinsics data may include, for example, the focal length, aperture, field-of-view, and/or resolution of the video cameras. The extrinsics data may include, for example, the position and orientation of the video cameras in relation to the scene and the depth-sensing cameras.

In some embodiments, during reconstruction of the scene, the extrinsics data corresponding to 3D location of the video cameras may be tweaked to improve the spatial alignment between the RGB image frames and the HSL depth image frames. For example, in cases where the overlapping field of view of the depth-sensing cameras is smaller than the overlapping field of view of the video cameras, the HSL depth image frame can be used as an anchor image and the extrinsics data corresponding to 3D location of the video cameras may be tweaked to align the RGB image frame with the HSL depth image frame.

For an example atlas frame that includes two sections corresponding to captured RGB image frames by video cameras 210a and 210b, the projection may be performed using two passes. In a first pass, the video data captured by video camera 210a may be projected onto the frame geometry based on the intrinsics and extrinsics data of video camera 210a. In a second pass, the video data captured by video camera 210b may be projected onto the frame geometry based on the intrinsics and extrinsics data of video camera 210b. The discrepancy between the two passes may enable the illusion of stereo effect. In the virtual environment, each pixel of the reconstructed scene may have two sets of RGB image information associated with the pixel (in addition to depth information).

Referring back to FIG. 4, at 450, method 400 may include capturing each frame of the reconstructed scene using a virtual imaging device to generate a second atlas frame sequence. The virtual imaging device can be, for example, one or more synthetic/virtual cameras located in the virtual environment. The positioning of the virtual imaging device may be neutral and set up to mimic a viewer's (e.g., a user of user device 140) natural position in a real environment.

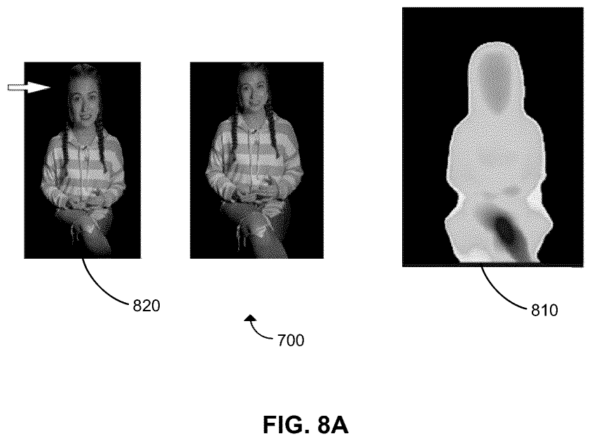

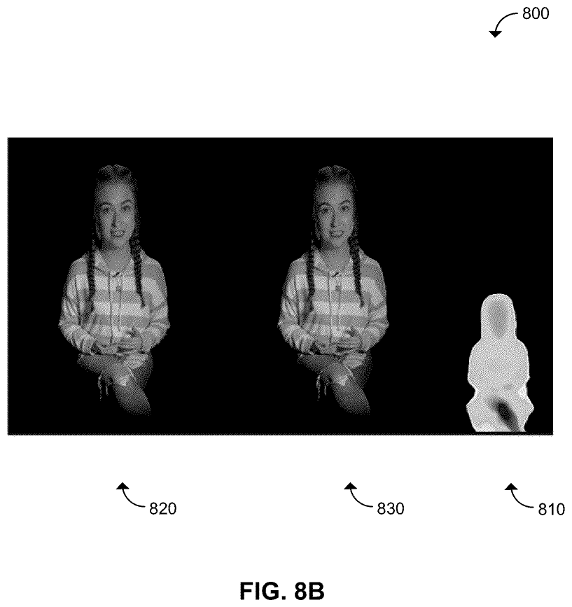

The second atlas frame sequence may include multiple atlas frames. Each atlas frame may include virtual video data and virtual depth data of the reconstructed scene. The virtual video data and the virtual depth data may be captured by the virtual imaging device. Reference is now made to FIGS. 8A and 8B. FIG. 8A shows visual representations of the reconstructed scene 700 (previously shown in FIG. 7), virtual depth data 810 and virtual video data 820. FIG. 8B shows a visual representation of an example atlas frame 800 of the second atlas frame sequence. The atlas frame 800 may include virtual depth data 810, and virtual video data 820, 830.

The virtual imaging device may capture the virtual depth data 810 for each atlas frame of the second atlas frame sequence. The virtual depth data 810 may include a depth image frame for each atlas frame of the second atlas frame sequence. The depth image frame may include depth information of the reconstructed scene in relation to the virtual location of the virtual imaging device within the virtual environment. In some embodiments, the virtual depth data may be encoded using a HSL scale. For example, a hue value of the HSL scale may include virtual depth information of the reconstructed scene. A hue value of 0 may be used for a maximum depth and a hue value of 360 may be used for a minimum depth. In some embodiments, the virtual depth data may be encoded using a greyscale value. For example, a greyscale value of 0 may be used for a maximum depth and a greyscale value of 1 may be used for a minimum depth. Using the HSL scale for encoding the captured depth data may enable a higher resolution of depth values compared with using greyscale values.

In some embodiments, a mask information of the reconstructed scene may be encoded using the luminance value of the HSL scale. For example, luminance value of white may correspond to depth data and luminance value of black may correspond to zero or no data. In some embodiments, the saturation value may also include the mask information to enable noise reduction. The mask information may enable culling areas not of interest in the atlas frames. This may improve the efficiency of system 100 by reducing the portion of the atlas frames that are processed in any subsequent processing steps.

The virtual imaging device may capture the virtual video data 820 and 830 as RGB image frames for each atlas frame of the second atlas frame sequence. The virtual video data 820 may be captured by the virtual imaging device in a first capture pass corresponding to a left eye perspective of a viewer (e.g., a user viewing the stereoscopic volumetric video on user device 140). The virtual video data 830 may be captured by the virtual imaging device in a second capture pass corresponding to a right eye perspective of a viewer (e.g., a user viewing the stereoscopic volumetric video on user device 140).

In some embodiments, the capture settings of the virtual imaging device may be adjusted to oversample specific portions of the reconstructed scene. The capture setting may be controlled by an operator of the system 100. In some cases, the capture settings may be automatically controlled based on stored parameters, for example, parameters stored in database 350 of FIG. 3.

As one example of the capture settings, the imaging plane of the virtual imaging device may be shifted with respect to the reconstructed scene during capture of virtual video data 820 and 830. The shift in the imaging plane may mimic the tilt of an optical lens of a real camera and distort the captured RGB image frame. The distortion may enable the distorted portion to be captured at a higher image resolution (e.g., higher pixel density of the RGB image frame) compared with other portions of the reconstructed scene.

In some embodiments, the imaging plane of the virtual imaging device may be shifted to capture a top portion of a reconstructed scene at a higher image resolution compared with other portions of the reconstructed scene. The top portion of the reconstructed scene may, for example, include a face of a human subject included in the reconstructed scene. A human viewer of the provided stereoscopic volumetric video may focus more attention on the face portion of any human subjects included in the video. The disclosed systems and methods may provide higher realism in the provided stereoscopic volumetric video by capturing the face portion of human subjects at a higher image resolution compared with other portions of the scene.

In some embodiments, the second atlas frame sequence may also include additional data, for example audio data and metadata. The second atlas frame sequence may be generated in any suitable format. For example, the second atlas frame sequence may be generated as .mp4 files that can be stored for offline viewing. In some embodiments, the atlas frames of the second atlas frame sequence may be streamed for real-time applications.

Referring back to FIG. 4, at 460, method 400 may include providing the stereoscopic volumetric video of the scene to a user device (e.g., user device 140 of FIG. 1). In some embodiments, method 400 may be performed to provide the stereoscopic volumetric video in real-time (e.g., for telepresence or live streaming applications). In some embodiments, method 400 may be performed to provide the stereoscopic volumetric video for offline viewing. For example, the captured video data and depth data of a scene may be received and stored. Later, the stored data may be retrieved and processed. The generated second atlas frame sequence may then be stored for offline viewing.

In some embodiments, the user device 140 may include a rendering tool to render the stereoscopic volumetric video based on the generated second atlas frame sequence. The rendering tool may provide a scene rendering based on the image and spatial information included in the virtual video data and the virtual depth data for each atlas frame included in the second atlas frame sequence. This may provide the viewer with a stereoscopic volumetric video of the captured scene. For example, the rendering tool may include a shader that updates a vertex mesh to change the image and spatial data provided to the viewer based on the virtual video data and the virtual depth data for each frame of the second atlas frame sequence.

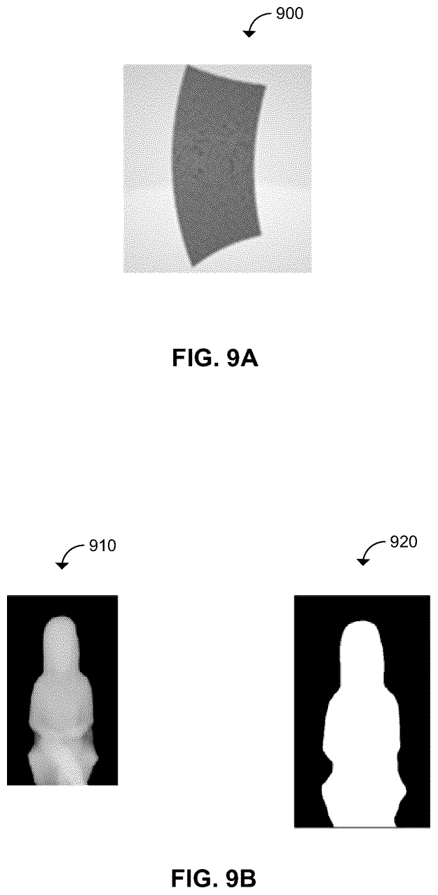

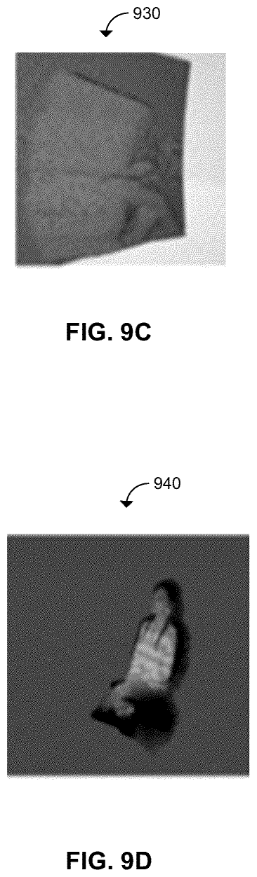

Reference is now made to FIG. 9A showing an example vertex mesh 900. In some embodiments, the vertex mesh may have a non-uniform density of vertices. For example, the vertex mesh may have a higher density of vertices in a portion of the mesh corresponding to a portion of the recreated scene that was captured at higher image resolution at 450.

Method 400 may include generating multiple UV maps that are usable by the rendering tool to provide the scene rendering. The UV maps may be generated by, for example, processing system 120 of FIG. 1.

In some embodiments, a first UV map may be generated corresponding to virtual video data 820. The first UV map may be used by the rendering tool to generate rendering corresponding to the left eye perspective of the viewer. For example, the first UV map may be used by a shader to apply materials to the vertex mesh to generate the rendering corresponding to the left eye perspective of the viewer.

A second UV map may be generated corresponding to virtual video data 830. The second UV map may be used by the rendering tool to generate rendering corresponding to the right eye perspective of the viewer. For example, the second UV map may be used by a shader to apply materials to the vertex mesh to generate the rendering corresponding to the right eye perspective of the viewer.

The first UV map and the second UV map may specify how image pixel data included in the virtual video data is mapped to vertices of the vertex mesh. The U coordinates of the UV map may specify horizontal coordinates of the vertex mesh and the V coordinates of the UV map may specify vertical coordinates. In some embodiments, the first UV map and the second UV map may include compensation for any distortion introduced into the captured image, for example, where the imaging plane of the virtual imaging device was shifted with respect to the reconstructed scene during capture of virtual video data 820 and 830. In some embodiments, where a portion of the captured image was distorted to capture that portion at a higher image resolution, the first UV map and the second UV map can include compensation that applies materials to the vertex mesh to restore the undistorted image while retaining a higher resolution (higher density of vertices) compared with other portions of the vertex mesh.

A third UV map may be generated corresponding to virtual depth data 810. The third UV map may be used by the rendering tool to render the spatial geometry of the captured scene. For example, the third UV map may be used by a shader to displace vertices of the vertex mesh based on the virtual depth data to recreate the 3D geometry of the captured scene.

Referring now to FIG. 9B, shown therein is a visual representation of an example greyscale depth map 910 and an example mask 920 based on virtual depth data 810. In some embodiments, where the HSL scale was used to encode the virtual depth data, the HSL scale may be decoded to generate the greyscale depth map 910 and the mask 920.

For example, the hue values may be decoded to floating point greyscale values. The greyscale depth map 910 may include the decoded greyscale values containing the virtual depth information for each pixel of the depth image frame. The saturation and luminance values may be multiplied against each other to reduce noise and generate mask 920. Mask 920 may be used by the shader to determine which vertices of the vertex map to render (white pixels) and which vertices of the vertex map to not render (black pixels).

Reference is now made to FIGS. 9C and 9D. FIG. 9C shows a visual representation 930 of the vertex mesh that is partially modified based on the virtual depth data 810 and the virtual video data 820, 830. FIG. 9D shows a visual representation of a rendering 940 generated after modifying the vertex mesh based on the virtual video data and virtual depth data. In some embodiments, method 400 may include masking edges and unused vertices of the vertex mesh to generate rendering 940. The rendering tool may generate a rendering 940 for each atlas frame of the second atlas frame sequence to provide a stereoscopic volumetric video of the captured scene to a viewer.

The present invention has been described here by way of example only. Various modification and variations may be made to these exemplary embodiments without departing from the spirit and scope of the invention, which is limited only by the appended claims.

1. A computer-implemented method for providing stereoscopic volumetric video of a scene, the method comprising:
receiving, by a processor, captured video data of the scene from a first imaging device and a second imaging device, the first imaging device and the second imaging device being synchronized to capture data at the same time and being positioned to provide a first overlapping field of view that includes the scene;
receiving, by the processor, captured depth data of the scene from a third imaging device and a fourth imaging device, the third imaging device and the fourth imaging device being synchronized to capture data at the same time and being positioned to provide a second overlapping field of view that includes the scene;
combining, by the processor, the captured video data and the captured depth data to generate a first atlas frame sequence comprising multiple atlas frames, wherein each atlas frame of the first atlas frame sequence includes the captured video data and the captured depth data for a given synchronized capture time;
processing, by the processor, each atlas frame of the first atlas frame sequence to generate a reconstructed scene in a virtual environment;
capturing, by the processor, each frame of the reconstructed scene using a virtual imaging device to generate a second atlas frame sequence comprising multiple atlas frames, wherein each atlas frame of the second atlas frame sequence includes virtual video data and virtual depth data of the reconstructed scene; and
providing, by the processor, the stereoscopic volumetric video of the scene based on the virtual video data and the virtual depth data.

2. The method of claim 1, wherein an imaging plane of the virtual imaging device is shifted with respect to the reconstructed scene to capture a portion of the reconstructed scene at a higher image resolution compared with the other portions of the reconstructed scene.

3. The method of claim 1, wherein the method is performed to provide the stereoscopic volumetric video of the scene to a user device in real-time.

4. The method of claim 1, wherein the first imaging device and the second imaging device are high-resolution color video cameras.

5. The method of claim 1, wherein the third imaging device and the fourth imaging device are infrared depth-sensing cameras.

6. The method of claim 1, wherein the second overlapping field of view is smaller than the first overlapping field of view.

7. The method of claim 1, wherein the captured depth data is encoded using a hue saturation luminance (HSL) scale, wherein a hue value of the HSL scale includes depth information of the scene and a luminance value of the HSL scale includes mask information of the scene.

8. The method of claim 1, wherein, before processing each atlas frame of the first atlas frame sequence to generate the reconstructed scene, the method further comprises editing the first atlas frame sequence to select only a portion of the first atlas frame sequence for processing.

9. The method of claim 8, wherein editing the first atlas frame sequence to select only a portion of the first atlas frame sequence for processing comprises:
transcoding the first atlas frame sequence into a proxy sequence, wherein the proxy sequence corresponds to a smaller file size compared with the first atlas frame sequence;
using the proxy sequence to make one or more selections; and
editing the first atlas frame sequence to correspond to the one or more selections.

10. The method of claim 1, further comprising receiving, by the processor, intrinsics data and extrinsics data of each imaging device; and wherein processing each atlas frame of the first atlas frame sequence to generate the reconstructed scene comprises:
reconstructing a frame geometry based on the captured depth data, the intrinsics data of the third imaging device and the fourth imaging device, and the extrinsics data of the third imaging device and the fourth imaging device; and
projecting the captured video data onto the frame geometry using a first pass corresponding to video data captured by the first imaging device and based on the intrinsics data and the extrinsics data of the first imaging device, and a second pass corresponding to video data captured by the second imaging device and based on the intrinsics data and the extrinsics data of the second imaging device.

11. The method of claim 2, wherein the portion of the reconstructed scene captured at the higher image resolution includes a face portion of a subject.

12. The method of claim 1, wherein capturing each frame of the reconstructed scene using a virtual imaging device to generate a second atlas frame sequence comprises:
capturing first virtual video data in a first capture pass corresponding to a left eye perspective of a viewer of the stereoscopic volumetric video;
capturing second virtual video data in a second capture pass corresponding to a right eye perspective of a viewer of the stereoscopic volumetric video; and
capturing the virtual depth data of the reconstructed scene in relation to a virtual location of the virtual imaging device in the virtual environment.

13. The method of claim 1, wherein the virtual depth data is encoded using a hue saturation luminance (HSL) scale, wherein a hue value of the HSL scale includes virtual depth information of the reconstructed scene in relation to the virtual location and a luminance value of the HSL scale includes mask information of the reconstructed scene.

14. The method of claim 12, wherein providing the stereoscopic volumetric video of the scene based on the virtual video data and the virtual depth data comprises:
generating a first UV map corresponding to the first virtual video data, the first UV map usable to apply material to an output mesh to generate rendering corresponding to the left eye perspective of the viewer of the stereoscopic volumetric video;
generating a second UV map corresponding to the second virtual video data, the second UV map usable to apply material to the output mesh to generate rendering corresponding to the right eye perspective of the viewer of the stereoscopic volumetric video; and
generating a third UV map corresponding to the virtual depth data, the third UV map usable to displace vertices of the output mesh to recreate geometry of the scene.

15. A system for providing stereoscopic volumetric video of a scene, the system comprising:
a processor in communication with a first imaging device, a second imaging device, a third imaging device and a fourth imaging device, wherein:
the first imaging device and the second imaging device are positioned to provide a first overlapping field of view that includes the scene and are synchronized to capture video data of the scene at the same time; and
the third imaging device and the fourth imaging device are positioned to provide a second overlapping field of view that includes the scene and are synchronized to capture depth data at the same time; and
a memory storing instructions executable by the processor;
wherein the processor is configured to:
receive the captured video data of the scene from the first imaging device and the second imaging device;
receive the captured depth data of the scene from the third imaging device and the fourth imaging device;
combine the captured video data and the captured depth data to generate a first atlas frame sequence comprising multiple atlas frames, wherein each atlas frame of the first atlas frame sequence includes the captured video data and the captured depth data for a given synchronized capture time;
process each atlas frame of the first atlas frame sequence to generate a reconstructed scene in a virtual environment;
capture each frame of the reconstructed scene using a virtual imaging device to generate a second atlas frame sequence comprising multiple atlas frames, wherein each atlas frame of the second atlas frame sequence includes virtual video data and virtual depth data of the reconstructed scene; and
provide the stereoscopic volumetric video of the scene based on the virtual video data and the virtual depth data.

16. The system of claim 15, wherein an imaging plane of the virtual imaging device is shifted with respect to the reconstructed scene to capture a portion of the reconstructed scene at a higher image resolution compared with the other portions of the reconstructed scene.

17. (canceled)

18. The system of claim 15, wherein the first imaging device and the second imaging device are high-resolution color video cameras.

19. The system of claim 15, wherein the third imaging device and the fourth imaging device are infrared depth-sensing cameras.

20. (canceled)

21. (canceled)

22. (canceled)

23. (canceled)

24. The system of claim 15, wherein the processor is further configured to receive intrinsics data and extrinsics data of each imaging device; and wherein the processor being configured to process each atlas frame of the first atlas frame sequence to generate the reconstructed scene comprises the processor being configured to:
reconstruct a frame geometry based on the captured depth data, the intrinsics data of the third imaging device and the fourth imaging device, and the extrinsics data of the third imaging device and the fourth imaging device; and
project the captured video data onto the frame geometry using a first pass corresponding to video data captured by the first imaging device and based on the intrinsics data and the extrinsics data of the first imaging device, and a second pass corresponding to video data captured by the second imaging device and based on the intrinsics data and the extrinsics data of the second imaging device.

25. (canceled)

26. The system of claim 15, wherein the processor being configured to capture each frame of the reconstructed scene using a virtual imaging device to generate a second atlas frame sequence comprises the processor being configured to:
capture first virtual video data in a first capture pass corresponding to a left eye perspective of a viewer of the stereoscopic volumetric video;
capture second virtual video data in a second capture pass corresponding to a right eye perspective of a viewer of the stereoscopic volumetric video; and
capture the virtual depth data of the reconstructed scene in relation to a virtual location of the virtual imaging device in the virtual environment.

27. (canceled)

28. (canceled)
